(19) United States
(12) Patent Application Publication
(10) Pub. No.: US 2024/0302945 A1
(43) Pub. Date: Sep. 12, 2024

(54) VIRTUAL NETWORK COMPUTING WITH EXTRA KEYBOARD LAYOUT

(71) Applicant: MICRO FOCUS LLC, Santa Clara, CA (US)

(72) Inventors: Mingxiang Zhao, Shanghai (CN); Xiao Long Liu, Shanghai (CN); YangHua Hu, Shanghai (CN); Songpei Jin, Shanghai (CN)

(73) Assignee: MICRO FOCUS LLC, SANTA CLARA, CA (US)

(21) Appl. No.: 18/118,598

(22) Filed: Mar. 7, 2023

(51) Int. Cl. G06F 3/0484; G06F 3/04886; H04L 41/40; H04L 65/1069

(52) U.S. Cl. CPC G06F 3/0484; G06F 3/04886; H04L 41/40; H04L 65/1069

(57) ABSTRACT

Methods, systems, and techniques are provided for displaying objects in virtual network computing (VNC). For example, a VNC connection may be established between a first device and a second device, where the VNC connection enables a synchronization of an interactive display layout from the first device to the second device. Subsequently, after the VNC connection is established, a page structure of the first device may be retrieved based on an application programming interface (API) on the second device. In some embodiments, based on the retrieved page structure, one or more non-interactive objects on the second device may be displayed, where the one or more non-interactive objects are displayed on top of at least a portion of the interactive display layout at the second device.

### FIELD OF THE DISCLOSURE

The present disclosure is generally directed to virtual network computing (VNC), in particular, toward displaying objects in a VNC system.

### BACKGROUND

Virtual Network Computing (VNC) is a graphical device-sharing system that uses a Remote Frame Buffer (RFB) protocol to remotely control another device. For example, VNC transmits inputs (e.g., keyboard inputs, mouse inputs, gestures, taps, long-presses, swipes, etc.) from one device to another, relaying the graphical-screen updates, over a network. In some cases, VNC may be used for remote technical support, accessing files on a work computer from a home computer or vice versa, or otherwise accessing a remote device from a local device.

### BRIEF SUMMARY

Example aspects of the present disclosure include:

A method for displaying objects in a VNC system, the method comprising: establishing a VNC connection between a first device and a second device, the VNC connection enabling a synchronization of an interactive display layout from the first device to the second device; retrieving, based at least in part on an application programming interface (API) on the second device, a page structure of the first device after the VNC connection is established; and displaying one or more non-interactive objects on the second device based at least in part on the retrieved page structure, the one or more non-interactive objects being displayed on top of at least a portion of the interactive display layout at the second device.

Any of the aspects herein, wherein retrieving the page structure comprises: retrieving the page structure of the first device in an extensible markup language (XML) type.

Any of the aspects herein, wherein the XML type comprises specified properties for each of a plurality of objects displayed on the first device according to the page structure.

Any of the aspects herein, wherein the specified properties for each of the plurality of objects comprise an x-coordinate, a y-coordinate, a width, a height, an index, a name, or a combination thereof, for each of the plurality of objects.

Any of the aspects herein, wherein the plurality of objects comprises a plurality of buttons of an alpha-numerical keyboard layout.

Any of the aspects herein, wherein displaying the one or more non-interactive objects on top of at least the portion of the interactive display layout at the second device prevents a user of the second device to interact with elements of the interactive display layout at the second device that are beneath the one or more non-interactive objects.

Any of the aspects herein, wherein the one or more non-interactive objects comprise a semi-transparent display of an alpha-numerical keyboard layout, and wherein the alpha-numerical keyboard layout is displayed on the first device.

Any of the aspects herein, further comprising: detecting an interaction made by a user of the second device, the interaction corresponding to a location on the interactive display layout at the second device where the one or more non-interactive objects are being displayed; and processing the interaction on the interactive display layout at the first device.

A system for displaying objects in VNC, comprising: a processor; and a memory storing data for processing by the processor, the data, when processed, causes the processor to: establish a VNC connection between a first device and a second device, the VNC connection enabling a synchronization of an interactive display layout from the first device to the second device; retrieve, based at least in part on an API on the second device, a page structure of the first device after the VNC connection is established; and display one or more non-interactive objects on the second device based at least in part on the retrieved page structure, the one or more non-interactive objects being displayed on top of at least a portion of the interactive display layout at the second device.

Any of the aspects herein, wherein the data stored in the memory that, when processed causes the processor to retrieve the page structure causes the system to: retrieve the page structure of the first device in an XML type.

Any of the aspects herein, wherein the XML type comprises specified properties for each of a plurality of objects displayed on the first device according to the page structure.

Any of the aspects herein, wherein the specified properties for each of the plurality of objects comprise an x-coordinate, a y-coordinate, a width, a height, an index, a name, or a combination thereof, for each of the plurality of objects.

Any of the aspects herein, wherein the plurality of objects comprises a plurality of buttons of an alpha-numerical keyboard layout.

Any of the aspects herein, wherein displaying the one or more non-interactive objects on top of at least the portion of the interactive display layout at the second device prevents a user of the second device to interact with elements of the interactive display layout at the second device that are beneath the one or more non-interactive objects.

Any of the aspects herein, wherein the one or more non-interactive objects comprise a semi-transparent display of an alpha-numerical keyboard layout, and wherein the alpha-numerical keyboard layout is displayed on the first device.

Any of the aspects herein, wherein the memory stores further data for processing by the processor that, when processed, causes the processor to: detect an interaction made by a user of the second device, the interaction corresponding to a location on the interactive display layout at the second device where the one or more non-interactive objects are being displayed; and process the interaction on the interactive display layout at the first device.

A system for displaying objects in VNC, comprising: means to establish a VNC connection between a first device and a second device, the VNC connection enabling a synchronization of an interactive display layout from the first device to the second device; means to retrieve, based at least in part on an API on the second device, a page structure of the first device after the VNC connection is established; and means to display one or more non-interactive objects on the second device based at least in part on the retrieved page structure, the one or more non-interactive objects being displayed on top of at least a portion of the interactive display layout at the second device.

Any of the aspects herein, further comprising: means to retrieve the page structure of the first device in an XML type.

Any of the aspects herein, wherein the XML type comprises specified properties for each of a plurality of objects displayed on the first device according to the page structure.

Any of the aspects herein, wherein the specified properties for each of the plurality of objects comprise an x-coordinate, a y-coordinate, a width, a height, an index, a name, or a combination thereof, for each of the plurality of objects.

Any of the aspects herein, wherein the plurality of objects comprises a plurality of buttons of an alpha-numerical keyboard layout.

Any of the aspects herein, wherein displaying the one or more non-interactive objects on top of at least the portion of the interactive display layout at the second device prevents a user of the second device to interact with elements of the interactive display layout at the second device that are beneath the one or more non-interactive objects.

Any of the aspects herein, wherein the one or more non-interactive objects comprise a semi-transparent display of an alpha-numerical keyboard layout, and wherein the alpha-numerical keyboard layout is displayed on the first device.

Any of the aspects herein, further comprising: means to detect an interaction made by a user of the second device, the interaction corresponding to a location on the interactive display layout at the second device where the one or more non-interactive objects are being displayed; and means to process the interaction on the interactive display layout at the first device.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present disclosure will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 depicts a system in accordance with embodiments of the present disclosure;

FIG. 2 depicts an interactive VNC display in accordance with embodiments of the present disclosure;

FIG. 3 depicts an interactive VNC display with a keyboard layout in accordance with embodiments of the present disclosure;

FIG. 4 depicts a block diagram of a system in accordance with embodiments of the present disclosure;

FIG. 5 depicts a process in accordance with embodiments of the present disclosure;

FIG. 6 depicts a process in accordance with embodiments of the present disclosure; and

FIG. 7 depicts a process in accordance with embodiments of the present disclosure.

### DETAILED DESCRIPTION

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, and/or may be added, merged, or left out altogether (e.g., all described acts or events may not be necessary to carry out the disclosed techniques according to different embodiments of the present disclosure). In addition, while certain aspects of this disclosure are described as being performed by a single module or unit for purposes of clarity, it should be understood that the techniques of this disclosure may be performed by a combination of units or modules associated with, for example, a computing device.

In one or more examples, the described methods, processes, and techniques may be implemented in hardware, software, firmware, or combinations thereof. If implemented in software, the functions may be stored as one or more instructions or code on a computer-readable medium and executed by a hardware-based processing unit. Alternatively or additionally, functions may be implemented using machine learning models, neural networks, artificial neural networks, or combinations thereof (alone or in combination with instructions). Computer-readable media includes non-transitory computer-readable media, which corresponds to a tangible medium such as data storage media (e.g., random-access memory (RAM), read-only memory (ROM), electrically erasable programmable ROM (EEPROM), flash memory, or any other medium that can be used to store desired program code in the form of instructions or data structures and that can be accessed by a computer).

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Instructions may be executed by one or more processors, such as one or more digital signal processors (DSPs), general purpose microprocessors (e.g., Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core i5-4670K and i-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors; or any other general purpose microprocessors), graphics processing units (e.g., Nvidia Geforce RTX 2000-series processors, Nvidia Geforce RTX 3000-series processors, AMD Radeon RX 5000-series processors, AMD Radeon RX 6000-series processors, or any other graphics processing units), application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements. The processors listed herein are not intended to be an exhaustive list of all possible processors that can be used for implementation of the described techniques, and any future iterations of such chips, technologies, or processors may be used to implement the techniques and embodiments of the present disclosure as described herein.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

Various aspects of the present disclosure will be described herein with reference to drawings that may be schematic illustrations of idealized configurations.

As described previously, Virtual Network Computing (VNC) is a graphical device-sharing system that uses a Remote Frame Buffer (RFB) protocol to remotely control another device. For example, VNC transmits inputs (e.g., keyboard inputs, mouse inputs, gestures, taps, long-presses, swipes, etc.) from one device to another, relaying the graphical-screen updates, over a network. In some cases, VNC may be used for remote technical support, accessing files on a work computer from a home computer or vice versa, or otherwise accessing a remote device from a local device.

In some examples, VNC may be enabled in part by a VNC server that is a program on a machine (e.g., device) that shares some screen (and may not be related to a physical display, such that the server can be “headless”) and allows a client to share control of the screen or access the screen. Additionally, a VNC client (or viewer) is a program that represents the screen data originating from the VNC server, receives updates from the VNC server, and presumably controls the screen by informing the VNC server of collected local input. A VNC protocol (e.g., RFB protocol transmits one graphic primitive from the VNC server to the VNC client (e.g., “Put a rectangle of pixel data at a specified X, Y position”) and event messages from the VNC client to the VNC server.

In some embodiments, an object (e.g., a soft keyboard) may disappear on VNC when a user is interacting with a local device (e.g., virtual device) to view or perform actions on a remote device (e.g., real or actual device), such as inputting a password and passcode on the local device. Additionally, users may experience difficulty to provide inputs (e.g., text inputs) if the object (e.g., keyboard) is not displayed through the VNC connection, even though the keyboard is present or appears on the remote device. As an example, when a user attempts to perform a “Tap” action on a button on the local device (e.g., “Login” button) after the user inputted a password completely through the VNC connection (e.g., web VNC component), the user may be prevented from performing the “Tap” action as expected.

In some embodiments, the user may be prevented from performing the “Tap” action based on the object (e.g., soft keyboard layout) being blocked from device screenshots and screen recordings when users are providing inputs on the local device (e.g., inputting password or passcode on the local device). That is, buttons on the local device (e.g., “Login” button) may be covered by the blocked or unseen object (e.g., the soft keyboard layout is present on top of the buttons even though the layout is not shown), thereby preventing the user from interacting with the buttons (e.g., performing the “Tap” action). For example, the “Login” button may be non-interactive at that time based on the soft keyboard layout being present over the “Login” button on the remote or actual device, while the soft keyboard layout is blocked from being displayed on the local or virtual device.

It is with respect to the above issues and other problems that the embodiments presented herein were contemplated.

As described herein, an Application Programming Interface (API) is provided on a device which can retrieve the page structure of the device (e.g., in XML type). The API may allow users to do automation tests against their own applications on the device. Relying on the page structure and corresponding XML objects (e.g., with properties like “x,” “y,” “width,” “height,” “index,” “name,” etc.), the API can draw up each button from a keyboard (e.g., and/or other types of objects) and assemble and combinate the objects into a dummy semi-transparent keyboard web layout above the VNC component. In some embodiments, the dummy semi-transparent keyboard web layout may not respond to any actions from the end users. Additionally, operation instructions will be passed to the VNC component below, such that VNC interactions will not be blocked. Accordingly, the dummy semi-transparent keyboard web layout enables users to know a real state of the soft keyboard on the device and guide the users to perform operations through the layout.

The API and techniques provided herein may improve interaction with remote devices through a web VNC component at local devices for users. Additionally, the API and techniques may enable the users to have more accurate real-time user experiences when using the VNC component.

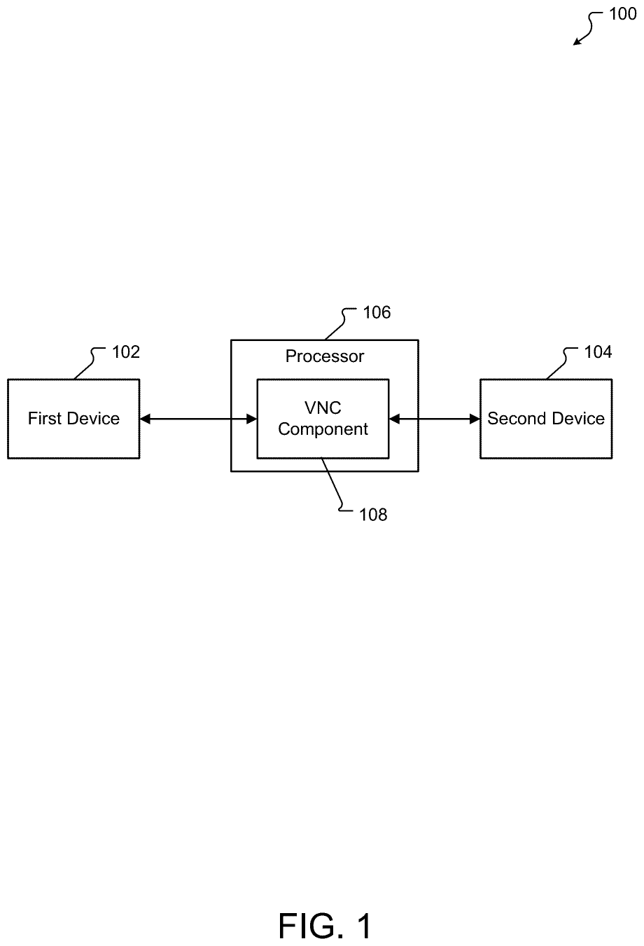

Referring now to FIG. 1, a system 100 is shown in accordance with embodiments of the present disclosure. The system 100 may comprise a first device 102, a second device 104, and a processor 106. In some embodiments, the first device 102 and the second device 104 may each represent one of a various types of user equipment, such as personal computers, mobile computing devices, smartphones, laptops, desktop, tablets, etc. The processor 106 may be any processor described herein or any similar electronic processor.

As described herein, the processor 106 may be configured to support a VNC component 108 that enables a VNC connection between the first device 102 and the second device 104. For example, the VNC connection may be a graphical device-sharing connection that uses protocols (e.g., RFB protocol) to remotely control the first device 102 and/or the second device 104 from the opposite device or another device. The VNC component 108 may transmit inputs (e.g., keyboard inputs, mouse inputs, gestures, taps, long-presses, swipes, etc.) from one device to another, relaying the graphical-screen updates, over a network. In some examples, the VNC component 108 may be used for remote technical support (e.g., for an information technology (IT) specialist to remotely access a device for troubleshooting and/or performing various operations on the device), accessing files on a work computer from a home computer (or vice versa), or otherwise accessing a remote device from a local device.

In some cases, one or more objects may disappear on the VNC connection when a user is interacting with a local device to view or perform actions on a remote device. For example, the object(s) may be blocked from being displayed in device screenshots and screen recordings when users are providing inputs on the local device using the VNC connection.

Methods, systems, and techniques are provided herein for retrieving a page structure of the remote device (e.g., in XML type) and drawing objects on the local device based on the page structure. For example, the page structure may include properties for the object(s), such as coordinates (e.g., “x” coordinate, “y” coordinate, etc.), a width, a height, an index, a name, etc. Accordingly, the methods, systems, and techniques can draw, assemble, and combinate the object(s) into a dummy semi-transparent web layout above the VNC component 108 on the local device. In some embodiments, the dummy semi-transparent web layout may not respond to any actions from the end users. Additionally, operation instructions will be passed to the VNC component 108 below, such that VNC interactions will not be blocked. Accordingly, the dummy semi-transparent web layout enables users to know a real state of object(s) being displayed on the remote device and guide the users to perform operations through the layout.

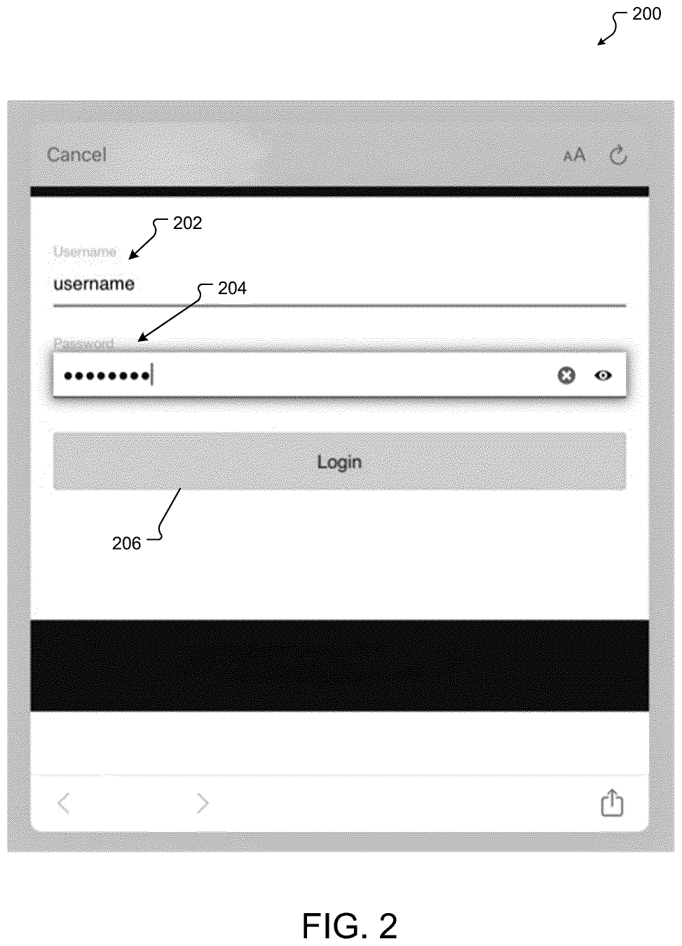

FIG. 2 depicts an interactive VNC display 200 in accordance with at least one embodiment of the present disclosure. The interactive VNC display 200 may implement aspects of or may be implemented by aspects of FIG. 1. For example, the interactive VNC display 200 may be displayed on a local device (e.g., through a VNC component 108) representing a graphical display of a remote device after a VNC connection is established between the local device and the remote device. Accordingly, the interactive VNC display 200 may enable a user at the local device to remotely control the remote device, such as providing a first input 202 (e.g., username) and a second input 204 (e.g., password or passcode). Additionally, the interactive VNC display 200 may be configured to enable the user at the local device to perform other actions, such as performing a “Tap” action on a button 206 (e.g., “Login” button).

However, in some examples, when trying to perform the “Tap” action on the button 206 after the first input 202 and the second input 204 are completely input (e.g., through a web VNC component), the user at the local device may be unable to perform the “Tap” action as expected. For example, a soft keyboard layout (e.g., and/or other objects) may be blocked from being displayed in device screenshots and screen recordings (e.g., captured through the VNC component) when users are providing the first input 202 and/or the second input 204 on the local device. That is, the button 206 may be covered by the soft keyboard layout, such that the button 206 is non-interactive at that time.

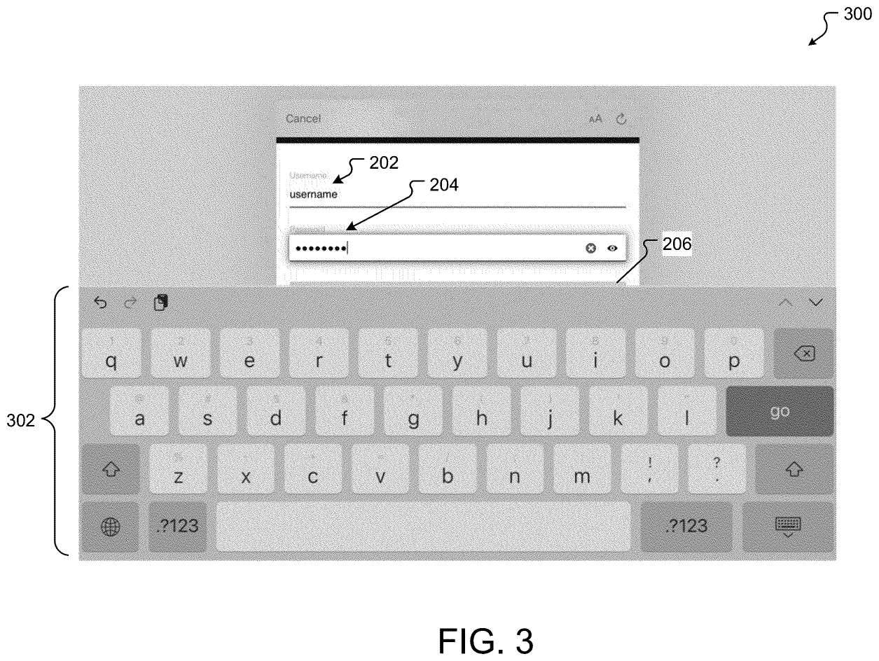

FIG. 3 depicts an interactive VNC display 300 with a keyboard layout 302 in accordance with at least one embodiment of the present disclosure. The interactive VNC display 300 may implement aspects of or may be implemented by aspects of FIGS. 1 and 2. For example, the interactive VNC display 300 may include the first input 202, the second input 204, and the button 206 as described with reference to FIG. 2. Additionally, the interactive VNC display 300 may be displayed on a local device (e.g., through a VNC component 108) representing a graphical display of a remote device after a VNC connection is established between the local device and the remote device. However, as described previously, the button 206 may be covered by a soft keyboard layout, such that the button 206 is non-interactive when users are providing the first input 202 and/or the second input 204 on the local device.

As described herein, an API on the local device is provided that can retrieve a page structure of the remote device in XML type. The API allows the users at the local device to perform automation tests against applications on the local device. Relying on the retrieved page structure and corresponding XML objects that include specific properties for each object (e.g., such as display coordinates, width, height, index, name, etc.), the VNC component and/or local device can draw up each button of the keyboard layout 302 and assemble and combinate all the objects into a dummy semi-transparent keyboard web layout above the VNC component. The semi-transparent keyboard web layout will not respond to any actions from the end users. Operation instructions will be passed to the VNC component below, such that VNC interactions will not be blocked. Additionally, the semi-transparent keyboard web layout can let users know the real state of the soft keyboard on the local device and guide them to perform operations through the layout.

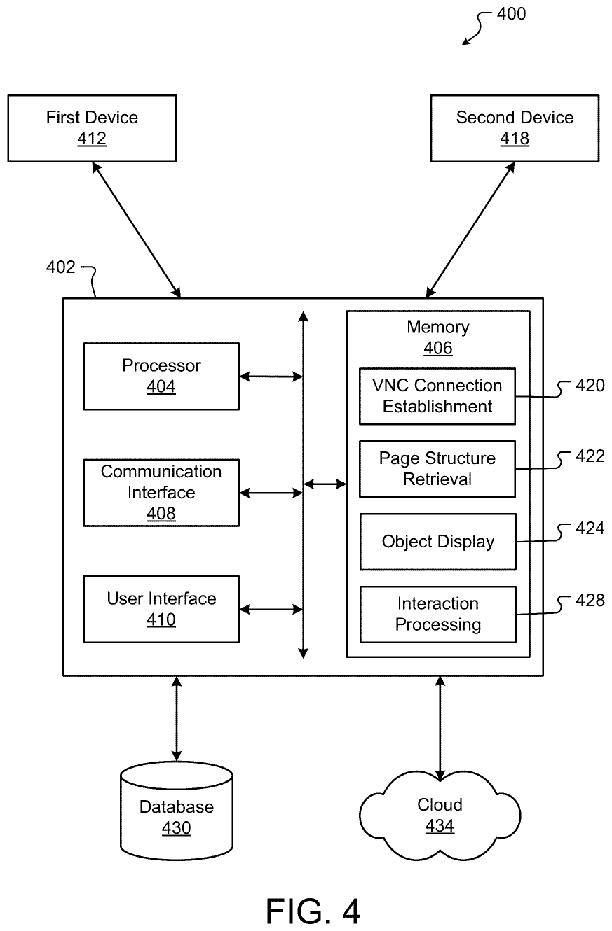

Turning to FIG. 4, a block diagram of a system 400 according to at least one embodiment of the present disclosure is shown. In one embodiment, system 400 is used to interconnect first device 412 and second device 418 for remote communications therebetween via a network, as described with reference to FIGS. 1-3. The system 400 comprises a computing device 402, a first device 412, a second device 418, a database 430, and/or a cloud 434 or other network. Systems according to other embodiments of the present disclosure may comprise more or fewer components than the system 400. For example, embodiments of the system 400 may omit the first device 412, the second device 418, one or more components of the computing device 402, the database 430, and/or the cloud 434. Additionally or alternatively, the system 400 may include additional devices.

The computing device 402 comprises a processor 404, a memory 406, a communication interface 408, and a user interface 410. Computing devices according to other embodiments of the present disclosure may comprise more or fewer components than the computing device 402. In some embodiments, the computing device 402 may be part of the first device 412 or the second device 418. Additionally or alternatively, each of the first device 412 and the second device 418 may comprise a respective computing device for enabling or performing the techniques described herein to display a keyboard (e.g., or additional objects) for VNC.

The processor 404 of the computing device 402 may be any processor described herein or any similar electronic processor. For example, the processor 404 may be represented by the processor 106 as described with reference to FIG. 1. The processor 404 may be configured to execute instructions or data stored in the memory 406, which the instructions or data may cause the processor 404 to carry out one or more computing steps utilizing or based on data received from the first device 412, the second device 418, the database 430, and/or the cloud 434.

The memory 406 may be or comprise RAM, DRAM, SDRAM, other solid-state memory, any memory described herein, or any other tangible, non-transitory memory for storing computer-readable data and/or instructions. The memory 406 may store information or data useful for completing and/or means to perform, for example, any step of the methods 500, 600, and/or 700 described herein, or of any other methods. The memory 406 may store, for example, instructions that support one or more functions of the first device 412 and/or the second device 418. For instance, the memory 406 may store content (e.g., instructions) that, when executed by the processor 404, enable VNC connection establishment 420, page structure retrieval 422, object display 424, and/or interaction processing 428.

The VNC connection establishment 420 enables the processor 404 to establish a VNC connection between the first device 412 and the second device 418, the VNC connection enabling a synchronization of an interactive display layout from the first device 412 to the second device 418. For example,

The page structure retrieval 422 enables the processor 404 to retrieve, based at least in part on an API on the second device 418, a page structure of the first device 412 after the VNC connection is established. For example, the page structure retrieval 422 enables the processor 404 to retrieve the page structure of the first device 412 in an XML type. In some examples, the XML type comprises specified properties for each of a plurality of objects displayed on the first device 412 according to the page structure. For example, the specified properties for each of the plurality of objects comprise an x-coordinate, a y-coordinate, a width, a height, an index, a name, or a combination thereof, for each of the plurality of objects. In some embodiments, the plurality of objects comprises a plurality of buttons of an alpha-numerical keyboard layout.

The object display 424 enables the processor 404 to display one or more non-interactive objects on the second device 418 based at least in part on the retrieved page structure, the one or more non-interactive objects being displayed on top of at least a portion of the interactive display layout at the second device 418. In some embodiments, displaying the one or more non-interactive objects on top of at least the portion of the interactive display layout at the second device 418 prevents a user of the second device 418 to interact with elements of the interactive display layout at the second device 418 that are beneath the one or more non-interactive objects. Additionally, in some embodiments, the one or more non-interactive objects comprise a semi-transparent display of an alpha-numerical keyboard layout, where the alpha-numerical keyboard layout is displayed on the first device 412.

The interaction processing 428 enables the processor 404 to detect an interaction made by a user of the second device 418, the interaction corresponding to a location on the interactive display layout at the second device 418 where the one or more non-interactive objects are being displayed. Subsequently, in some embodiments, the interaction processing 428 enables the processor 404 to process the interaction on the interactive display layout at the first device 412.

Content stored in the memory 406, if provided as in instruction, may, in some embodiments, be organized into one or more applications, modules, packages, layers, or engines. Alternatively or additionally, the memory 406 may store other types of content or data (e.g., machine learning models, artificial neural networks, deep neural networks, etc.) that can be processed by the processor 404 to carry out the various method and features described herein. Thus, although various contents of memory 406 may be described as instructions, it should be appreciated that functionality described herein can be achieved through use of instructions, algorithms, and/or machine learning models. The data, algorithms, and/or instructions may cause the processor 404 to manipulate data stored in the memory 406 and/or received from or via the first device 412, the second device 418, the database 430, and/or the cloud 434.

The computing device 402 may also comprise a communication interface 408. The communication interface 408 may be used for receiving image data or other information from an external source (such as the first device 412, the second device 418, the database 430, the cloud 434, and/or any other system or component not part of the system 400), and/or for transmitting instructions, images, or other information to an external system or device (e.g., another computing device 402, the first device 412, the second device 418, the database 430, the cloud 434, and/or any other system or component not part of the system 400). The communication interface 408 may comprise one or more wired interfaces (e.g., a USB port, an Ethernet port, a Firewire port) and/or one or more wireless transceivers or interfaces (configured, for example, to transmit and/or receive information via one or more wireless communication protocols such as 802.11a/b/g/n, Bluetooth, NFC, ZigBee, and so forth). In some embodiments, the communication interface 408 may be useful for enabling the computing device 402 to communicate with one or more other processors 404 or computing devices 402, whether to reduce the time needed to accomplish a computing-intensive task or for any other reason.

The computing device 402 may also comprise one or more user interfaces 410. The user interface 410 may be or comprise a keyboard, mouse, trackball, monitor, television, screen, touchscreen, and/or any other device for receiving information from a user and/or for providing information to a user. The user interface 410 may be used, for example, to receive a user selection or other user input regarding any step of any method described herein. Notwithstanding the foregoing, any required input for any step of any method described herein may be generated automatically by the system 400 (e.g., by the processor 404 or another component of the system 400) or received by the system 400 from a source external to the system 400. In some embodiments, the user interface 410 may be useful to enable a user (e.g., and/or technical support) to establish and facilitate a VNC connection between the first device 412 and the second device 418 based on the instructions to be executed by the processor 404 according to one or more embodiments of the present disclosure, and/or to modify or adjust a setting of other information displayed on the user interface 410 or corresponding thereto.

Although the user interface 410 is shown as part of the computing device 402, in some embodiments, the computing device 402 may utilize a user interface 410 that is housed separately from one or more remaining components of the computing device 402. In some embodiments, the user interface 410 may be located proximate one or more other components of the computing device 402, while in other embodiments, the user interface 410 may be located remotely from one or more other components of the computer device 402.

The database 430 may be configured to provide any such information to the computing device 402 or to any other device of the system 400 or external to the system 400, whether directly or via the cloud 434. In some embodiments, the database 430 may provide information for facilitating the VNC connection between the first device 412 and the second device 418.

The cloud 434 may be or represent the Internet or any other wide area network. The computing device 402 may be connected to the cloud 434 via the communication interface 408, using a wired connection, a wireless connection, or both. In some embodiments, the computing device 402 may communicate with the database 430 and/or an external device (e.g., a computing device) via the cloud 434.

The system 400 or similar systems may be used, for example, to carry out one or more aspects of any of the methods 500, 600, and/or 700 described herein. The system 400 or similar systems may also be used for other purposes.

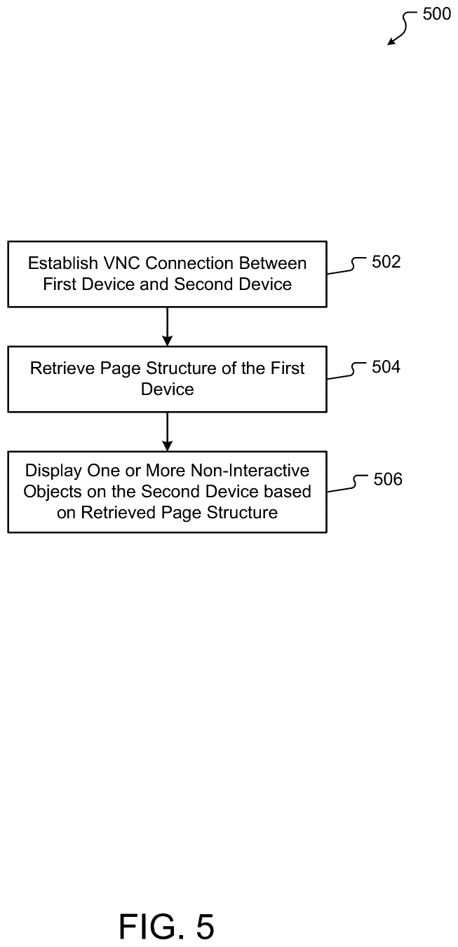

FIG. 5 depicts a method 500 that may be used, for example, to display objects in a VNC system and/or through a VNC connection.

The method 500 (and/or one or more steps thereof) may be carried out or otherwise performed, for example, by at least one processor. The at least one processor may be the same as or similar to the processor(s) 404 of the computing device 402 described above. The at least one processor may be part of a remote device and/or a local device. A processor other than any processor described herein may also be used to execute the method 500. The at least one processor may perform the method 500 by executing elements stored in a memory such as the memory 406. The elements stored in memory and executed by the processor may cause the processor to execute one or more steps of a function as shown in method 500. One or more portions of a method 500 may be performed by the processor executing any of the contents of memory, such as a VNC connection establishment 420, a page structure retrieval 422, an object display 424, and/or an interaction processing 428.

The method 500 comprises establishing a VNC connection between a first device and a second device, the VNC connection enabling a synchronization of an interactive display layout from the first device to the second device (step 502). In some examples, the first device may be a remote device (e.g., actual device), and the second device may be a local device (e.g., device that accesses the remote device through a VNC component).

The method 500 also comprises retrieving, based at least in part on an API on the second device, a page structure of the first device after the VNC connection is established (step 504). In some embodiments, the API may enable users to perform automation tests against applications on the first device (e.g., remote device).

The method 500 also comprises displaying one or more non-interactive objects on the second device based at least in part on the retrieved page structure, the one or more non-interactive objects being displayed on top of at least a portion of the interactive display layout at the second device (step 506). In some embodiments, displaying the one or more non-interactive objects on top of at least the portion of the interactive display layout at the second device may prevent a user of the second device to interact with elements of the interactive display layout at the second device that are beneath the one or more non-interactive objects. Additionally, the one or more non-interactive objects may comprise a semi-transparent display of an alpha-numerical keyboard layout, where the alpha-numerical keyboard layout is displayed on the first device.

The present disclosure encompasses embodiments of the method 500 that comprise more or fewer steps than those described above, and/or one or more steps that are different than the steps described above.

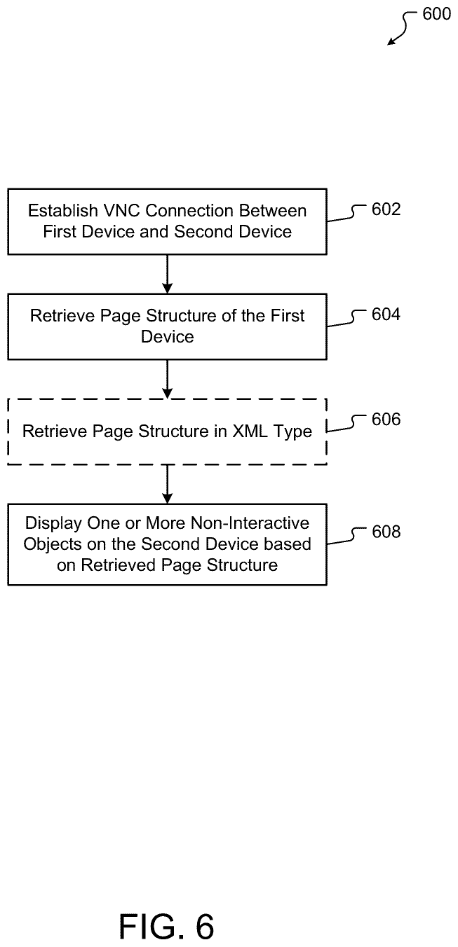

FIG. 6 depicts a method 600 that may be used, for example, to display objects in a VNC system and/or through a VNC connection based on properties of the objects retrieved through a page structure.

The method 600 (and/or one or more steps thereof) may be carried out or otherwise performed, for example, by at least one processor. The at least one processor may be the same as or similar to the processor(s) 404 of the computing device 402 described above. The at least one processor may be part of a remote device and/or a local device. A processor other than any processor described herein may also be used to execute the method 600. The at least one processor may perform the method 600 by executing elements stored in a memory such as the memory 406. The elements stored in memory and executed by the processor may cause the processor to execute one or more steps of a function as shown in method 600. One or more portions of a method 600 may be performed by the processor executing any of the contents of memory, such as a VNC connection establishment 420, a page structure retrieval 422, an object display 424, and/or an interaction processing 428.

The method 600 comprises establishing a VNC connection between a first device and a second device, the VNC connection enabling a synchronization of an interactive display layout from the first device to the second device (step 602). The method 600 also comprises retrieving, based at least in part on an API on the second device, a page structure of the first device after the VNC connection is established (step 604). Steps 602 and 604 may implement similar aspects of steps 502 and 504 as described with reference to FIG. 5.

In some embodiments, the method 600 also comprises retrieving the page structure of the first device in an XML type (step 606). Additionally, the XML type may comprise specified properties for each of a plurality of objects displayed on the first device according to the page structure. For example, the specified properties for each of the plurality of objects comprise an x-coordinate, a y-coordinate, a width, a height, an index, a name, or a combination thereof, for each of the plurality of objects. In some embodiments, the plurality of objects may comprise a plurality of buttons of an alpha-numerical keyboard layout.

The method 600 also comprises displaying one or more non-interactive objects on the second device based at least in part on the retrieved page structure, the one or more non-interactive objects being displayed on top of at least a portion of the interactive display layout at the second device (step 608). Step 608 may implement similar aspects of step 506 as described with reference to FIG. 5.

The present disclosure encompasses embodiments of the method 600 that comprise more or fewer steps than those described above, and/or one or more steps that are different than the steps described above.

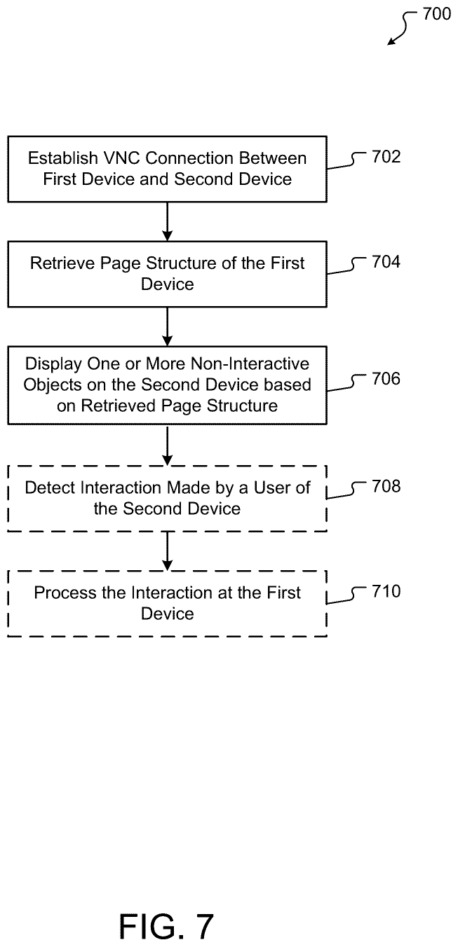

FIG. 7 depicts a method 700 that may be used, for example, to process an interaction performed in a VNC system and/or through a VNC connection.

The method 700 (and/or one or more steps thereof) may be carried out or otherwise performed, for example, by at least one processor. The at least one processor may be the same as or similar to the processor(s) 404 of the computing device 402 described above. The at least one processor may be part of a remote device and/or a local device. A processor other than any processor described herein may also be used to execute the method 700. The at least one processor may perform the method 700 by executing elements stored in a memory such as the memory 406. The elements stored in memory and executed by the processor may cause the processor to execute one or more steps of a function as shown in method 700. One or more portions of a method 700 may be performed by the processor executing any of the contents of memory, such as a VNC connection establishment 420, a page structure retrieval 422, an object display 424, and/or an interaction processing 428.

The method 700 comprises establishing a VNC connection between a first device and a second device, the VNC connection enabling a synchronization of an interactive display layout from the first device to the second device (step 702). The method 700 also comprises retrieving, based at least in part on an API on the second device, a page structure of the first device after the VNC connection is established (step 704). The method 700 also comprises displaying one or more non-interactive objects on the second device based at least in part on the retrieved page structure, the one or more non-interactive objects being displayed on top of at least a portion of the interactive display layout at the second device (step 706). Steps 702, 704, and 706 may implement aspects of steps 502, 504, and 506 as described with reference to FIG. 5 and/or steps 602, 604, and 608 as described with reference to FIG. 6.

The method 700 also comprises detecting an interaction made by a user of the second device, the interaction corresponding to a location on the interactive display layout at the second device where the one or more non-interactive objects are being displayed (step 708). The method 700 also comprises processing the interaction on the interactive display layout at the first device (step 710).

The present disclosure encompasses embodiments of the method 700 that comprise more or fewer steps than those described above, and/or one or more steps that are different than the steps described above.

Any of the steps, functions, and operations discussed herein can be performed continuously and automatically.

Additionally, as noted above, the present disclosure encompasses methods with fewer than all of the steps identified in FIGS. 5, 6, and 7 (and the corresponding description of the methods 500, 600, and 700), as well as methods that include additional steps beyond those identified in FIGS. 5, 6, and 7 (and the corresponding description of the methods 500, 600, and 700). The present disclosure also encompasses methods that comprise one or more steps from one method described herein, and one or more steps from another method described herein. Any correlation described herein may be or comprise a registration or any other correlation.

While the flowcharts have been discussed and illustrated in relation to a particular sequence of events, it should be appreciated that changes, additions, and omissions to this sequence can occur without materially affecting the operation of the disclosed embodiments, configuration, and aspects.

The exemplary systems and methods of this disclosure have been described in relation to displaying an extra keyboard in a VNC connection. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in conjunction with one embodiment, it is submitted that the description of such feature, structure, or characteristic may apply to any other embodiment unless so stated and/or except as will be readily apparent to one skilled in the art from the description. The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

As used herein, the singular forms “a,” “an,” and “the” are intended to include the plural forms as well, unless the context clearly indicates otherwise. It will be further understood that the terms “include,” “including,” “includes,” “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably and include any type of methodology, process, mathematical operation, or technique.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

1. A method for displaying objects in a virtual network computing system, the method comprising:
establishing a virtual network computing connection between a first device and a second device, the virtual network computing connection enabling a synchronization of an interactive display layout from the first device to the second device;
retrieving, based at least in part on an application programming interface on the second device, a page structure of the first device after the virtual network computing connection is established; and
displaying one or more non-interactive objects on the second device based at least in part on the retrieved page structure, the one or more non-interactive objects being displayed on top of at least a portion of the interactive display layout at the second device.

2. The method of claim 1, wherein retrieving the page structure comprises:
retrieving the page structure of the first device in an extensible markup language type.

3. The method of claim 2, wherein the extensible markup language type comprises specified properties for each of a plurality of objects displayed on the first device according to the page structure.

4. The method of claim 3, wherein the specified properties for each of the plurality of objects comprise an x-coordinate, a y-coordinate, a width, a height, an index, a name, or a combination thereof, for each of the plurality of objects.

5. The method of claim 3, wherein the plurality of objects comprises a plurality of buttons of an alpha-numerical keyboard layout.

6. The method of claim 1, wherein displaying the one or more non-interactive objects on top of at least the portion of the interactive display layout at the second device prevents a user of the second device to interact from interacting with elements of the interactive display layout at the second device that are beneath the one or more non-interactive objects.

7. The method of claim 1, wherein the one or more non-interactive objects comprise a semi-transparent display of an alpha-numerical keyboard layout, and wherein the alpha-numerical keyboard layout is displayed on the first device.

8. The method of claim 1, further comprising:
detecting an interaction made by a user of the second device, the interaction corresponding to a location on the interactive display layout at the second device where the one or more non-interactive objects are being displayed; and
processing the interaction on the interactive display layout at the first device.

9. A system for displaying objects in virtual network computing, comprising:
a processor; and
a memory storing data for processing by the processor, wherein the data, when processed, causes the processor to:
establish a virtual network computing connection between a first device and a second device, the virtual network computing connection enabling a synchronization of an interactive display layout from the first device to the second device;
retrieve, based at least in part on an application programming interface on the second device, a page structure of the first device after the virtual network computing connection is established; and
display one or more non-interactive objects on the second device based at least in part on the retrieved page structure, the one or more non-interactive objects being displayed on top of at least a portion of the interactive display layout at the second device.

10. The system of claim 9, wherein the data stored in the memory that, when processed, causes the processor to retrieve the page structure causes the system to:
retrieve the page structure of the first device in an extensible markup language type.

11. The system of claim 10, wherein the extensible markup language type comprises specified properties for each of a plurality of objects displayed on the first device according to the page structure.

12. The system of claim 11, wherein the specified properties for each of the plurality of objects comprise an x-coordinate, a y-coordinate, a width, a height, an index, a name, or a combination thereof, for each of the plurality of objects.

13. The system of claim 11, wherein the plurality of objects comprises a plurality of buttons of an alpha-numerical keyboard layout.

14. The system of claim 9, wherein displaying the one or more non-interactive objects on top of at least the portion of the interactive display layout at the second device prevents a user of the second device from interacting with elements of the interactive display layout at the second device that are beneath the one or more non-interactive objects.

15. The system of claim 9, wherein the one or more non-interactive objects comprise a semi-transparent display of an alpha-numerical keyboard layout, and wherein the alpha-numerical keyboard layout is displayed on the first device.

16. The system of claim 9, wherein the memory stores further data for processing by the processor that, when processed, causes the processor to:
detect an interaction made by a user of the second device, the interaction corresponding to a location on the interactive display layout at the second device where the one or more non-interactive objects are being displayed; and
process the interaction on the interactive display layout at the first device.

17. A system for displaying objects in virtual network computing, comprising:
means to establish a virtual network computing connection between a first device and a second device, the virtual network computing connection enabling a synchronization of an interactive display layout from the first device to the second device;
means to retrieve, based at least in part on an application programming interface on the second device, a page structure of the first device after the virtual network computing connection is established; and
means to display one or more non-interactive objects on the second device based at least in part on the retrieved page structure, the one or more non-interactive objects being displayed on top of at least a portion of the interactive display layout at the second device.

18. The system of claim 17, further comprising:
means to retrieve the page structure of the first device in an extensible markup language type.

19. The system of claim 18, wherein the extensible markup language type comprises specified properties for each of a plurality of objects displayed on the first device according to the page structure.

20. The system of claim 17, wherein the one or more non-interactive objects comprise a semi-transparent display of an alpha-numerical keyboard layout, and wherein the alpha-numerical keyboard layout is displayed on the first device.
